(19) United States
(12) Patent Application Publication
(10) Pub. No.: US 2007/0220302 A1
(43) Pub. Date: Sep. 20, 2007

(54) Session failover management in a high-availability server cluster environment

(76) Inventors: Brian G. Cline, Hebron, KY (US); James P. Galvin JR., Oak Ridge, NC (US); Mark Johnson, Cincinnati, OH (US); James W. Lawwill JR., Winchester, KY (US); Amir Perlman, Yahud (IL); Brian Pulito, Lexington, KY (US); Yaron Reinharts, Palmachim (IL); Uri Segev, Or-Yehuda (IL); Dror Yaffe, Gan Yavne (IL)

Correspondence Address: HOFFMAN, WARNICK & D'ALESSANDRO LLC, 75 STATE ST, 14TH FLOOR, ALBANY, NY, 12207, US

(21) Appl. No.: 11/363,676

(22) Filed: Feb. 28, 2006

(51) Int. Cl. G06F 11/00

(52) U.S. Cl. 714/4

(57) ABSTRACT

A system for session failover management in a server cluster environment, the system including one or more clusters, each cluster having one or more servers, each server having one or more partition, each partition identified by a partition ID and grouping one or more sessions, and a failover manager configured to detect the failure of any of the servers and effect the assignment any of the partitions on the failed server to another of the servers within the failed server's cluster.

### BACKGROUND OF THE INVENTION

Server clusters are often employed in high-availability computing environments to provide active or passive redundancy in the case of a server failure. This is typically implemented by configuring multiple servers within a cluster of servers with common applications, so that when one server running a particular application fails, failover may be performed by having another server within the same cluster stand in for the failed server by running the same application. Where servers within a cluster run applications that provide HyperText Transfer Protocol (HTTP) services to HTTP-based clients, failover is relatively easy to perform, since in any case multiple HTTP requests from the same HTTP-based client are server indifferent, allowing each HTTP request to be routed to different server within a server cluster for processing. However, in order to support session-based protocols, such as the Session Initiation Protocol (SIP), failover is more complex, as SIP messages are always sent to the same SIP container on the same SIP server. Furthermore, since a single SIP container might support tens of thousands of SIP sessions simultaneously, a failover that would entail a corresponding number of messages notifying SIP proxies which backup servers are taking over for which SIP sessions would be cumbersome and impractical.

### SUMMARY OF THE INVENTION

The present invention discloses a system and method for session failover management in a high-availability server cluster environment.

In one aspect of the present invention a system is provided for session failover management in a server cluster environment, the system including one or more clusters, each cluster having one or more servers, each server having one or more partitions, each partition identified by a partition ID and grouping one or more sessions, and a failover manager configured to detect the failure of any of the servers and effect the assignment any of the partitions on the failed server to another of the servers within the failed server's cluster.

In another aspect of the present invention any of the servers to which a failed server partition is assigned is configured to activate any of the sessions within the failed server partition.

In another aspect of the present invention the system further includes a server-partition mapper configured to maintain a mapping of each of the partitions to their servers.

In another aspect of the present invention any of the servers to which a failed server partition is assigned is configured to inform the server-partition mapper that it has taken over the failed server partition.

In another aspect of the present invention the system further includes a proxy configured to receive an incoming session-based protocol message, identify to which of the partitions the message belongs, consult the server-partition mapper to determine to which server the identified partition is mapped, and forward the message to the mapped server.

In another aspect of the present invention the system further includes a replication manager configured to replicate session objects, associated with any of the sessions on any of the servers within any of the clusters, to any other of the servers within the cluster.

In another aspect of the present invention the session is a SIP session.

In another aspect of the present invention a method is provided for session failover management in a server cluster environment, the method including defining one or more clusters, each cluster having one or more servers, each server having one or more partitions, each partition identified by a partition ID and grouping one or more sessions, detecting the failure of any of the servers, and effecting the assignment any of the partitions on the failed server to another of the servers within the failed server's cluster.

In another aspect of the present invention the method further includes activating any of the sessions within the failed server partition on the server to which a failed server partition is assigned.

In another aspect of the present invention the method further includes maintaining a mapping of each of the partitions to their servers.

In another aspect of the present invention the method further includes updating the mapping to indicate the server to which a failed server partition is assigned.

In another aspect of the present invention the method further includes receiving an incoming session-based protocol message, identifying to which of the partitions the message belongs, determining to which server the identified partition is mapped, and forwarding the message to the mapped server.

In another aspect of the present invention the method further includes replicating session objects, associated with any of the sessions on any of the servers within any of the clusters, to any other of the servers within the cluster.

In another aspect of the present invention a computer-implemented program is provided embodied on a computer-readable medium, the computer program including a first code segment operative to define one or more clusters, each cluster having one or more servers, each server having one or more partitions, each partition identified by a partition ID and grouping one or more sessions, a second code segment operative to detect the failure of any of the servers, and a third code segment operative to effect the assignment any of the partitions on the failed server to another of the servers within the failed server's cluster.

### BRIEF DESCRIPTION OF THE DRAWINGS

The present invention will be understood and appreciated more fully from the following detailed description taken in conjunction with the appended drawings in which:

FIG. 1 is a simplified high-level conceptual illustration of a system for session failover management in a high-availability server cluster environment, constructed and operative in accordance with a preferred embodiment of the present invention;

FIG. 2 is a simplified conceptual illustration of a system for session failover management in a high-availability server cluster environment, constructed and operative in accordance with a preferred embodiment of the present invention; and

FIGS. 3A and 3B, taken together, is a simplified flowchart illustration of an exemplary method of operation of the system of FIG. 2, operative in accordance with a preferred embodiment of the present invention.

### DETAILED DESCRIPTION OF THE INVENTION

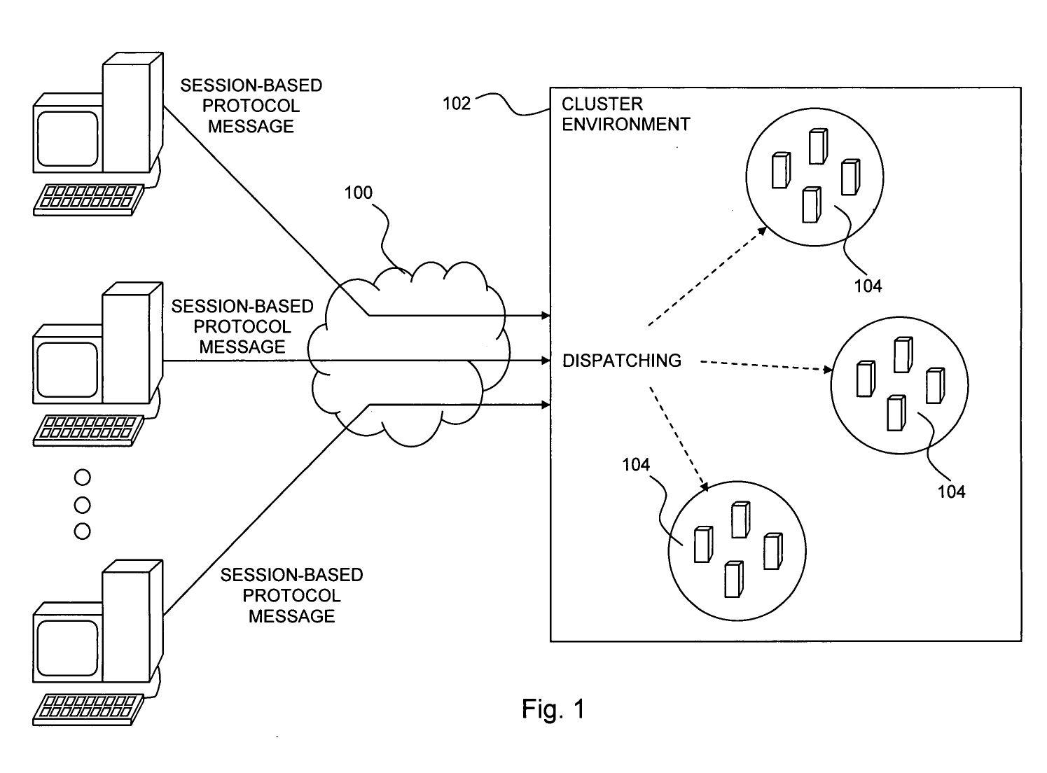

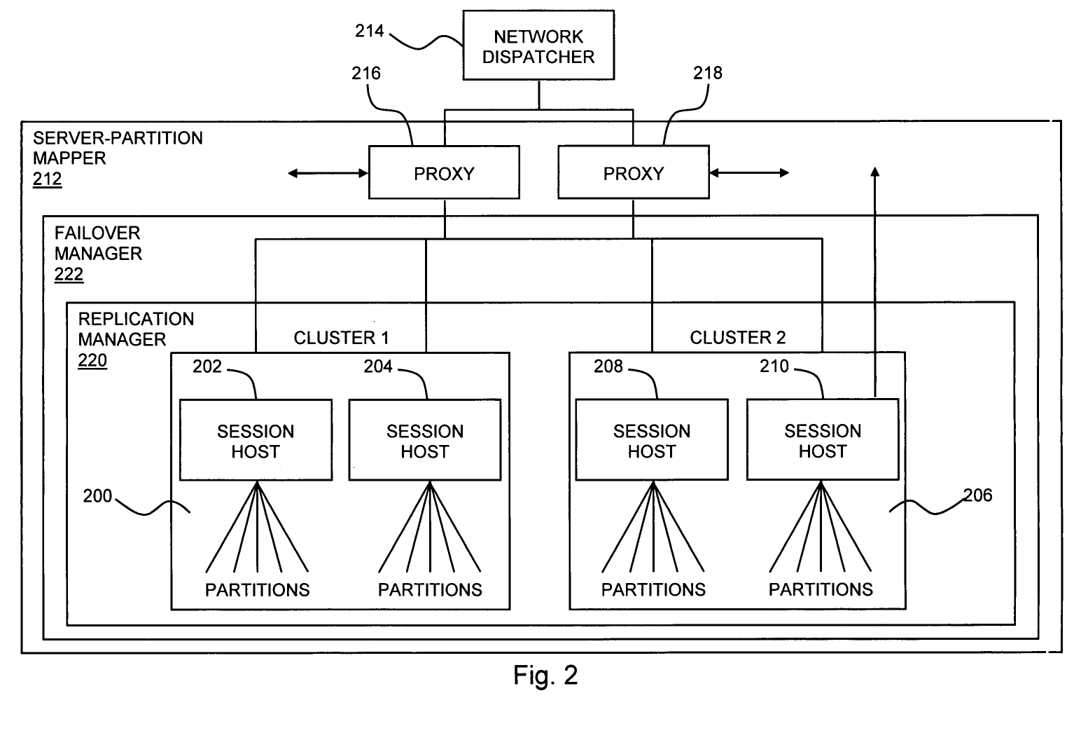

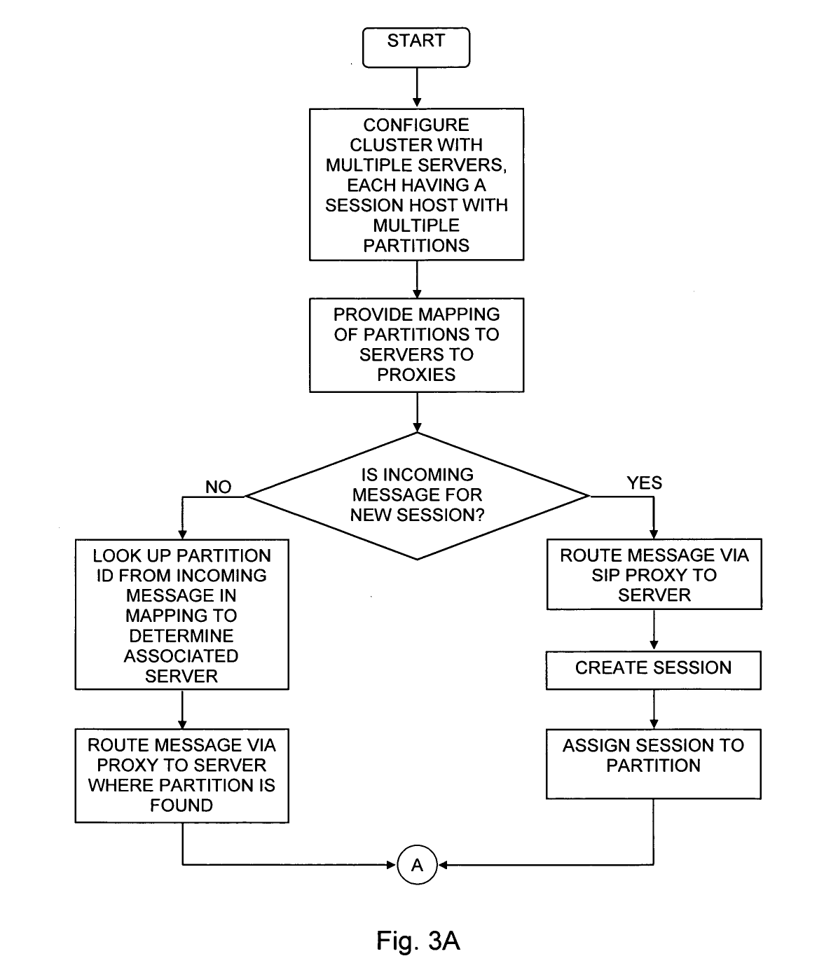

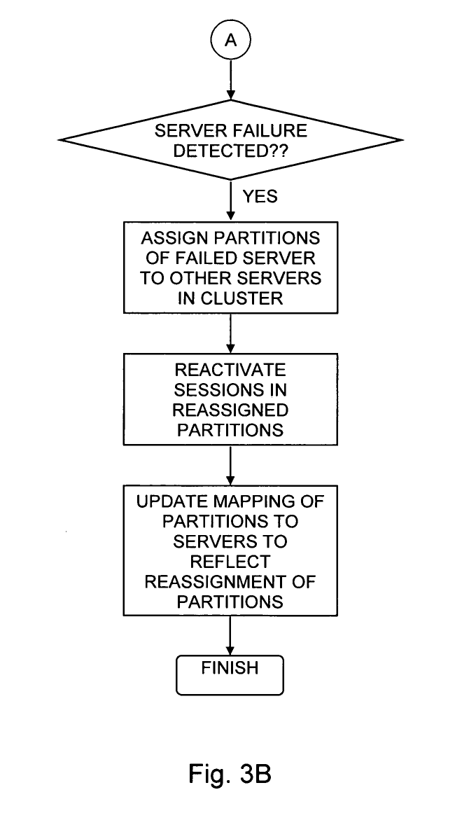

Reference is now made to FIG. 1, which is a simplified high-level conceptual illustration of a system for session failover management in a high-availability server cluster environment, constructed and operative in accordance with a preferred embodiment of the present invention. In the system of FIG. 1 multiple session-based protocol messages, such as SIP messages, are sent by multiple clients via a network 100, such as the Internet, to a cluster environment 102. Cluster environment 102 includes one or more server clusters 104 to which incoming session-based protocol messages are dispatched, such as for the establishment of SIP sessions. Cluster environment 102 and management thereof is described in greater detail hereinbelow with reference to FIGS. 2, 3A, and 3B.

Reference is now made to FIG. 2, which is a simplified conceptual illustration of a system for session failover management in a high-availability server cluster environment, constructed and operative in accordance with a preferred embodiment of the present invention, and additionally to FIGS. 3A and 3B, which, taken together, is a simplified flowchart illustration of an exemplary method of operation of the system of FIG. 2, operative in accordance with a preferred embodiment of the present invention. In the system and method of FIGS. 2-3B a cluster 200 is shown, labeled “Cluster 1”, and having two servers 202 and 204 acting as session hosts, such as in the form of SIP containers. A second cluster 206 is also shown, labeled “Cluster 2”, and having two servers 208 and 210, also acting as session hosts. Each session host divides the sessions that it manages into one or more partitions, giving each partition a partition ID that is preferably unique across all partitions within a cluster. Each server informs a server-partition mapper 212 of its own identity, such as its network address, as well as the partition IDs of its partitions.

An incoming session-based protocol message is received at a network dispatcher 214, which may be any IP sprayer, which forwards the message to any of one or more proxies, such as SIP proxies 216 and 218. Each proxy 216, 218 preferably sees each of clusters 200 and 206, and is able to forward session-based protocol messages to any of servers 202, 204, 208, and 210. Upon receipt of an incoming session-based protocol message from network dispatcher 214, if the message is part of a new session, such as may be effected via a SIP dialog, the proxy routes the message to any of servers 202, 204, 208, and 210, preferably deciding which server by using any known load balancing technique. The incoming message is received by the chosen server's session host, which creates the session and its related objects, and assigns the session to one of its partitions, also preferably deciding which partition by using any known load balancing technique. The session objects are preferably replicated to each of the servers in the cluster by a replication manager 220 to support failover.

Once the session has been created, all outgoing messages sent by the session host include both the session ID, as well as the partition ID to which the session belongs. Thereafter, upon receipt of an incoming message from network dispatcher 214, if the message is part of an existing session and includes a partition ID, the receiving proxy consults server-partition mapper 212 to determine to which server the partition belongs, and forwards the message to the indicated server.

Should a server fail, such as may be detected by a failover manager 222, each of the failed server's partitions is preferably assigned to one of the other servers in the cluster, preferably using known load balancing techniques such that the number of sessions managed by each of the servers after they have taken over the partitions of the failed server falls within load balancing thresholds. The assignment of a failed server's partitions is preferably managed by failover manager 222 and/or by a coordinating server designated by failover manager 222 from among the servers in the cluster. Each server that takes over a partition of the failed server activates the sessions assigned to the partition and informs server-partition mapper 212 of its own identity, such as its network address, as well as the partition ID of each partition it has taken over. Thereafter, upon receipt of an incoming message that belongs to a partition of a failed server, the receiving proxy consults server-partition mapper 212 to determine to which server the partition now belongs, and forwards the message to the indicated server.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a while and is not to be construed as limiting the invention to the embodiments shown. It is appreciated that various modifications may occur to those skilled in the art that, while not specifically shown herein, are nevertheless within the true spirit and scope of the invention.

What is claimed is:

1. A system for session failover management in a server cluster environment, the system comprising:
one or more clusters, each cluster having one or more servers, each server having one or more partitions, each partition identified by a partition ID and grouping one or more sessions; and
a failover manager configured to
detect the failure of any of said servers and
effect the assignment any of said partitions on said failed server to another of said servers within said failed server's cluster.

2. A system according to claim 1 wherein any of said servers to which a failed server partition is assigned is configured to activate any of said sessions within said failed server partition.

3. A system according to claim 1 and further comprising a server-partition mapper configured to maintain a mapping of each of said partitions to their servers.

4. A system according to claim 3 wherein any of said servers to which a failed server partition is assigned is configured to inform said server-partition mapper that it has taken over said failed server partition.

5. A system according to claim 3 and further comprising a proxy configured to
receive an incoming session-based protocol message,
identify to which of said partitions said message belongs,
consult said server-partition mapper to determine to which server said identified partition is mapped, and
forward said message to said mapped server.

6. A system according to claim 1 and further comprising a replication manager configured to replicate session objects, associated with any of said sessions on any of said servers within any of said clusters, to any other of said servers within said cluster.

7. A system according to claim 1 wherein said session is a SIP session.

8. A method for session failover management in a server cluster environment, the method comprising:
defining one or more clusters, each cluster having one or more servers, each server having one or more partitions, each partition identified by a partition ID and grouping one or more sessions;
detecting the failure of any of said servers; and
effecting the assignment any of said partitions on said failed server to another of said servers within said failed server's cluster.

9. A method according to claim 8 and further comprising activating any of said sessions within said failed server partition on said server to which a failed server partition is assigned.

10. A method according to claim 8 and further comprising maintaining a mapping of each of said partitions to their servers.

11. A method according to claim 10 and further comprising updating said mapping to indicate the server to which a failed server partition is assigned.

12. A method according to claim 10 and further comprising:
receiving an incoming session-based protocol message;
identifying to which of said partitions said message belongs;
determining to which server said identified partition is mapped; and
forwarding said message to said mapped server.

13. A method according to claim 8 and further comprising replicating session objects, associated with any of said sessions on any of said servers within any of said clusters, to any other of said servers within said cluster.

14. A computer-implemented program embodied on a computer-readable medium, the computer program comprising:
a first code segment operative to define one or more clusters, each cluster having one or more servers, each server having one or more partitions, each partition identified by a partition ID and grouping one or more sessions;
a second code segment operative to detect the failure of any of said servers; and
a third code segment operative to effect the assignment any of said partitions on said failed server to another of said servers within said failed server's cluster.
